(19) United States
(12) Patent Application Publication
(10) Pub. No.: US 2005/0082516 A1
(43) Pub. Date: Apr. 21, 2005

(54) Weed extractor

(76) Inventor: Kenneth O. Hayes, Bloomington, IN (US)

Correspondence Address: BAKER & DANIELS, 300 NORTH MERIDIAN STREET, SUITE 2700, INDIANAPOLIS, IN, 46204-1782, US

(21) Appl. No.: 10/689,337

(22) Filed: Oct. 20, 2003

(51) Int. Cl. B66F 3/00

(52) U.S. Cl. 254/132

(57) ABSTRACT

A tool for extracting weeds includes a body member having a blade fixed to the body, for example at a first end, and a handle fixed to the body, for example at an opposite second end. An arcuate support, which serves as a fulcrum or pivot when extracting weeds, is coupled to the body member by a web. The web is fixed to the body between the blade and handle and spans between the body and the support along the length of the body member. The support includes an arcuate face having a first and second end. The first face end may be fixed to the body adjacent the blade and the second face end may be spaced from the body between the blade and handle.

### BACKGROUND

1. Field of the Invention

The present invention relates to hand tools and, in particular, to weed extraction tools.

2. Description of the Related Art

Various types of weed extraction tools have been developed to remove weeds or other unwanted vegetation from landscape such as lawns and gardens. Some such known tools include a member which functions as a pivot against the landscape adjacent the weed to be removed. The pivot provides a convenient fulcrum and reduces the force otherwise necessary from the user. As pressure is applied to remove the weed, the pivot member may damage grass or other ground cover against which the pivot member rests. Additionally, known weed extraction tools are often constructed of multiple metal components, some of which include welds and complex mechanisms which may break or otherwise fail. Chemical compounds used for landscape care and moisture present on the vegetation may also corrode the metal components and mechanisms. Additionally, such known weed extraction tools tend to be expensive because of the cost of the materials and manufacturing process required to construct them.

What is needed is a durable and relatively inexpensive weed extractor that can be easily manipulated by hand and minimizes damage to adjacent landscape.

### SUMMARY OF THE INVENTION

The inventive tool for extracting weeds includes a body member having a blade fixed to the body, for example at a first end, and a handle fixed to the body, for example at an opposite second end. An arcuate support, which serves as a fulcrum or pivot when extracting weeds, is coupled to the body member by a web. The web is fixed to the body between the blade and handle and spans between the body and the support along the length of the body member. The support includes an arcuate face having a first and second end. The first face end may be fixed to the body adjacent the blade and the second face end may be spaced from the body between the blade and handle.

An exemplary embodiment of the tool may be generally constructed of plastic or a composite such as a glass fiber reinforced polymer. The body member, blade, web, support face, and handle may be molded as a single integral tool, or may be constructed of two or more components and then assembled. For example, the handle may include an outer resilient material layer such as foam rubber for providing a cushioned hand grip. In the exemplary embodiment, the body member includes an I-beam shaped cross-section; however, other cross-sectional shapes may be used.

The blade in the exemplary embodiment includes two tines forming a fork for engaging the base of a weed or other vegetation. Upon engaging the weed, the support face may be rested against the surrounding landscape, ground cover, or ground and used as a pivot. Upon pressing the handle downward toward the ground, the support face pivots along the arcuate surface and against the landscape, forcing the blade away from the ground, thereby extracting the undesired weed or other vegetation from the ground.

Advantageously, the exemplary tool may be molded from a plastic or a composite, thereby providing an inexpensive yet durable weed extraction tool. Additionally, the inventive support face provides an arcuate surface for contact and pivoting on the landscape near the undesired weed. The arcuate surface is sized to distribute the pressure applied to the ground cover upon which it rests, thereby minimizing damage to adjacent vegetation. Advantageously, an exemplary embodiment of the inventive tool is constructed of plastic or a composite that is more resistant than metal to corrosion from water and chemical compounds typically used for treating landscapes.

In one form, the present invention provides a tool including a body member having a longitudinal axis, a blade fixed to the body, an arcuate support spaced from the longitudinal axis and having a length, and a web substantially spanning the arcuate support and the body along the length of the arcuate support.

In another form, the present invention provides a tool including a body member having a longitudinal body axis and a first and a second body end, a blade fixed to the body, and a support having a face, the face having a first and a second face end, the face defining a midline connecting the first and second face ends, the midline located in a plane coincident with the longitudinal body axis, the face being arcuate along the midline.

In yet another form, the present invention provides a method of making a tool including the steps of forming a body member having a first and a second body end, forming a blade fixed at the first body end, forming an arcuate support fixed to the body between the first and second body ends, and forming a web fixed between the body and the arcuate support.

### DESCRIPTION OF THE DRAWINGS

The above mentioned and other features and objects of this invention, and the manner of attaining them, will become more apparent and the invention itself will be better understood by reference to the following description of an exemplary embodiment of the invention taken in conjunction with the accompanying drawings, wherein:

FIG. 1 is a perspective view of an exemplary embodiment of the inventive weed extractor;

FIG. 2 is a top view of the exemplary embodiment of FIG. 1;

FIG. 3 is a bottom view of the exemplary embodiment of FIG. 1;

FIGS. 4 and 5 are side views of the exemplary embodiment of FIG. 1;

FIG. 6 is an end view from the blade end of the exemplary embodiment of FIG. 1; and

FIG. 7 is an end view from the handle end of the exemplary embodiment of FIG. 1.

Corresponding reference characters indicate corresponding parts throughout the several views. Although the drawings represent an embodiment of the present invention, the drawings are not necessarily to scale and certain features may be exaggerated to better illustrate and explain the present invention. The exemplifications set out herein illustrates an embodiment of the invention, and such exemplifications are not to be construed as limiting the scope of the invention in any manner.

### DESCRIPTION OF THE INVENTION

The exemplary embodiment disclosed below is not intended to be exhaustive or limit the invention to the precise forms disclosed in the following detailed description. Rather, the embodiment is chosen and described so that others skilled in the art may utilize its teaching. While the description that follows refers to weed extractors, the teachings of the present invention are adaptable to any tool.

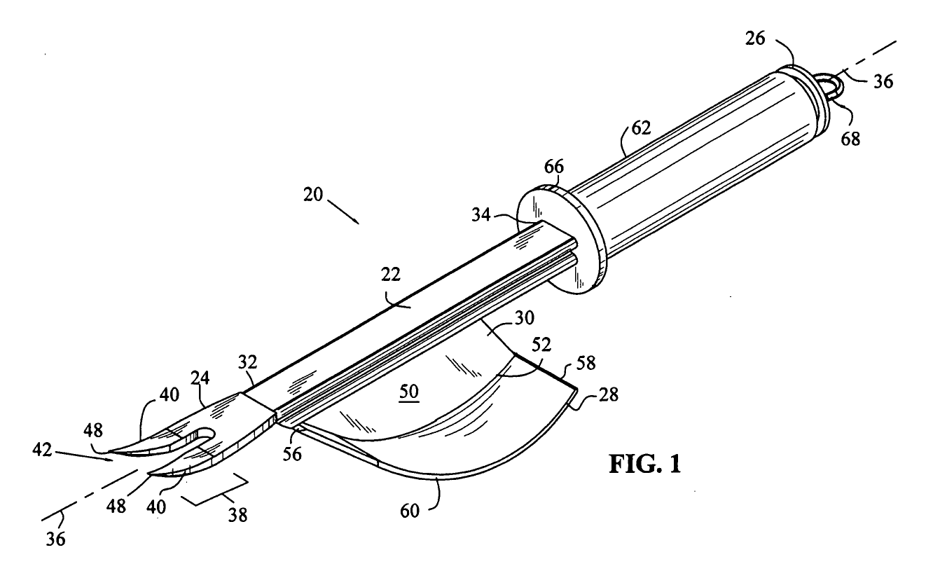

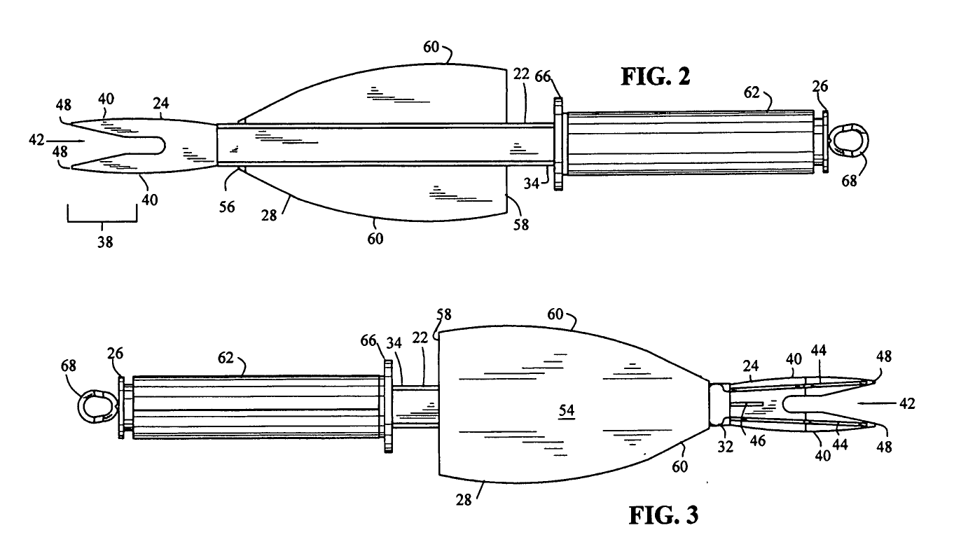

Referring to FIG. 1, exemplary tool 20 generally includes body member 22, blade 24, handle 26, support 28, and web 30. The components of exemplary tool 20 may be integrally formed, for example molded of plastic or a composite such as a glass reinforced polymer, or may also be formed of two or more separate components and coupled together to provide blade 24 at first body end 32, handle 26 at second body end 34, and support 28 and web 30 therebetween. Alternatively, blade 24 and handle 26 may be coupled to body 22 at a location other than ends 32 and 34.

As can be appreciated from FIG. 1, body member 22 of exemplary tool 20 includes an I-beam shaped cross-section; however, other cross-sections may also be used, for example circular or rectangular and solid or hollow. The I-beam shaped cross-section allows body 22 to resist bending along longitudinal axis 36 while minimizing the volume of material comprising body 22.

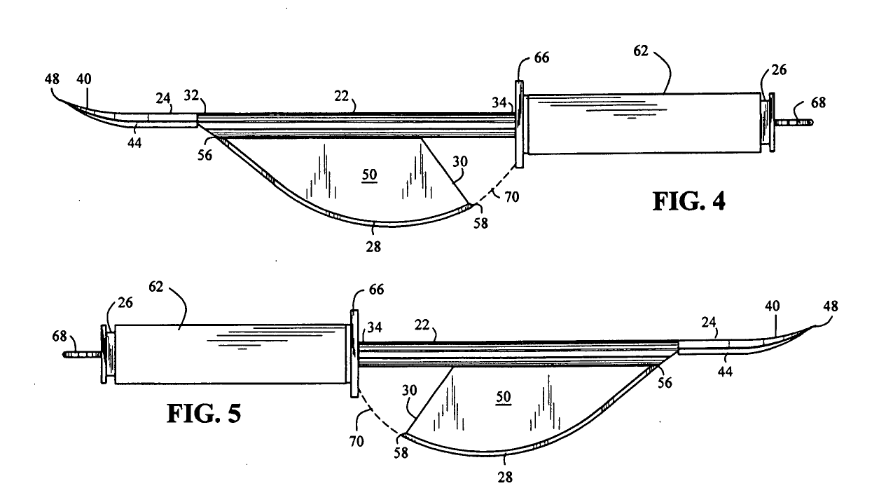

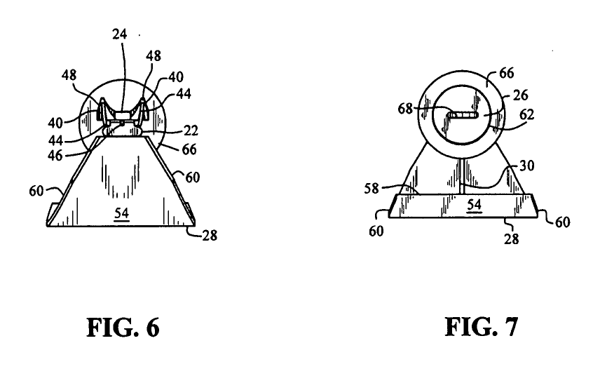

Blade 24 may be fixed to body 22 at first body end 32. Blade 24 may include fork 38, having a pair of tines 40 defining a substantially V-shaped slot 42 therebetween; however, other blade configurations may also be used, for example blade 24 may include more than two tines or may have a differently shaped slot or no slot at all. Each tine 40 may be curved upward, away from support 28 and longitudinal axis 36, as is best shown in FIGS. 4 and 5, and may include reinforcing beads 44 as shown in FIGS. 3 and 4-6. Blade 24 may also include reinforcing bead 46 located along longitudinal axis 36 and adjacent first body end 32. Reinforcing beads 44 and 46 provide additional strength to blade 24 for resisting bending along longitudinal axis 36. Referring again to FIG. 1, tines 40 may be tapered or otherwise sharpened or pointed at ends 48. Although blade 24 of exemplary tool 20 is formed from plastic or a composite, blade 24 may also be formed from metal or another rigid material. Blade 24 may also comprise another device for engaging an undesirable weed, for example a pair of opposing members that grip the weed to extract it.

Web 30 spans between body 22 and support 28 along the length of body 22 and provides support for support 28. Web 30 substantially spans the length of support 28; however, support 28 may include portions along the length which are not coupled by web 30, including portions adjacent ends 56 and 58 and portions therebetween. Web 30 may be substantially within a plane that is coincident along a segment of longitudinal axis 36. Edge 52 of web 30, which is locate away from body 22, may be arcuate and couples web 30 to support 28.

Support 28 includes face 54 having first face end 56 and second face end 58. For exemplary tool 20, first face end 56 is located proximate to or may be fixed to body 22. In contrast, as shown most clearly in FIGS. 4 and 5, second face end 58 may be spaced from body 22. Referring to FIG. 3, support 28 may include at least a portion that is substantially wider than blade 24 in a direction perpendicular to longitudinal axis 36 (between outer edges 60). As can be appreciated from FIGS. 4-7, face 54 of support 28 is substantially arcuate relative to longitudinal axis 36 and may be substantially linear in a direction perpendicular to outer edges 60. Additionally, as can be appreciated from FIG. 7, support 28 is coupled to web 30 along a midline which is located approximately midway between outer edges 60 of support 28.

Referring again to FIG. 1, handle 28 is fixed to second body end 34 of body 22; however, handle 26 may also be hollow such that body 22 extends through the length of handle 26. Handle 26 may include grip 62 located around the circumference of handle 26.

Grip 62 provide comfort and added friction for gripping and manipulating tool 20 by hand. Grip 62 may be formed from a resilient material, for example foam rubber. Handle 26 may also include hand stop 66 at the end of handle 26 adjacent first body end 34. Hand stop 66 helps to prevent fingers or other portions of a user's hand from slipping along longitudinal axis 36 toward blade 24 when engaging blade 24 of the base of a weed. Handle 26 may also include a loop or other hanger 68 for storage of tool 20.

The utility of the exemplary tool 20 may be exemplified while held by handle 26, and used for extracting weeds or other unwanted vegetation from a landscape. Specifically, slot 42 of blade 24 may be engaged around the stem of an unwanted weed, for example at the weed's base, or the root may be engaged using slot 42 by extending tines 40 into the ground just under the base of the undesired weed. After blade 24 is engaged with the weed, support 28 is positioned against the ground, vegetation, or other landscape adjacent the weed, providing a pivot about which tool 20 may be rotated. As handle 26 is forced toward the ground and pivot 28 is in contact with the ground, blade 24 will be forced upward away from the ground, thereby extracting the undesired weed from the ground.

Advantageously, support 28 is arcuately shaped and sufficiently wide between edges 60 to distribute the pressure applied to the vegetation or other landscape upon which it rests to minimize injuring the vegetation or other landscape. The width of support 28 between edges 60 is preferable at least approximately 1½ inches (3.8 cm) and more preferably at least approximately 2 inches (5.1 cm). Additionally, web 30 accommodates the use of plastic or composite materials by providing support that prevents surface 28 from deflecting any more than a minimal amount, if at all. Surface 28 at second face end 58 and face 54 may be alternatively extended arcuately back (shown as feature 70) to body 22 to provide additional strength to support 28, if desired. It is understood that the preferred illustrated embodiment provides better rigidity and strength while requiring less material, therefore lowering cost.

Exemplary tool 20 may be formed by injection molding a substantially rigid thermoplastic polymer such as glass-filled nylon into an appropriate die mold. For example, a mold designed to integrally form body member 22, blade 24, web 30, support 28, and handle 26. Grip 62 may then be assembled with tool 20. Alternatively, one or more other components may also be separately constructed of the same or a different material and then fixed to tool 20. For example, blade 24 may be formed of metal and then attached to body 22.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A tool, comprising:
a body member having a longitudinal axis;
a blade fixed to said body;
an arcuate support spaced from said longitudinal axis and having a length; and
a web substantially spanning said arcuate support and said body along said length of said arcuate support.

2. The tool of claim 1, wherein
said body member includes a first and a second body end, said blade fixed at said first body end; and
said face includes a first face end and a second face end, said first face end being fixed to said body adjacent said blade, said second face end spaced from said body between said first body end and said second body end.

3. The tool of claim 2, wherein said face includes a portion between said first face end and said second face end being substantially wider than said blade.

4. The tool of claim 1, wherein
said face of said support transverse to a midline of said face is substantially linear;
said web is substantially planar; and
said face is substantially perpendicular to said web.

5. The tool of claim 1, further comprising a handle adjacent said second body end.

6. The tool of claim 5, further comprising a loop hanger fixed to at least one of said body and said handle.

7. The tool of claim 1, wherein said blade defines a pair of forked tines.

8. The tool of claim 7, further comprising reinforcing beads along at least one of said tines and a central portion of said blade.

9. The tool of claim 1, wherein said body includes an I-beam cross-section.

10. The tool of claim 1, wherein at least one of said body, said blade, said arcuate support, and said web are integrally formed from a composite material.

11. A tool, comprising:
a body member having a longitudinal body axis and a first and a second body end;
a blade fixed to said body; and
a support having a face, said face having a first and a second face end, said face defining a midline connecting said first and second face ends, said midline located in a plane coincident with said longitudinal body axis, said face being arcuate along said midline.

12. The tool of claim 11, further comprising a web coupling said body member to said support along said midline.

13. The tool of claim 12, wherein said face includes a portion between said first face end and said second face end being substantially wider than said blade.

14. The tool of claim 11, further comprising a handle fixed to said body adjacent said second body end.

15. The tool of claim 14, further comprising a loop hanger fixed to at least one of said shaft and said hanger.

16. The tool of claim 12, wherein said blade includes a pair of forked tines.

17. The tool of claim 16, further comprising reinforcing beads along at least one of said forked tines and a central portion of said blade.

18. The tool of claim 12, wherein said body includes an I-beam cross-section.

19. The tool of claim 12, wherein at least one of said body, said blade, said arcuate support, and said web are integrally formed from a composite material.

20. A method of making a tool, comprising the steps of:
forming a body member having a first and a second body end;
forming a blade fixed at said first body end;
forming an arcuate support fixed to said body between said first and second body ends; and
forming a web fixed between said body and said arcuate support.
